(19) United States
(12) Patent Application Publication
(10) Pub. No.: US 2015/0050637 A1
(43) Pub. Date: Feb. 19, 2015

(54) SYSTEM AND METHOD FOR EARLY WARNING AND RECOGNITION FOR STUDENT ACHIEVEMENT IN SCHOOLS

(71) Applicants: Becky James-Hatter, St. Louis, MO (US); Kristen Slaughter, Balwin, MO (US); Sam Were, St. Louis, MO (US); Ashley Beggs, Benton, MO (US); Crystal Lewis, Columbia, MO (US)

(72) Inventors: Becky James-Hatter, St. Louis, MO (US); Kristen Slaughter, Balwin, MO (US); Sam Were, St. Louis, MO (US); Ashley Beggs, Benton, MO (US); Crystal Lewis, Columbia, MO (US)

(73) Assignee: Big Brothers Big Sisters of Eastern Missouri, St. Louis, MO (US)

(21) Appl. No.: 14/462,144

(22) Filed: Aug. 18, 2014

Related U.S. Application Data
(60) Provisional application No. 61/866,832, filed on Aug. 16, 2013.

(51) Int. Cl. G09B 5/08

(52) U.S. Cl. CPC G09B 5/08
USPC 434/362; 434/322

(57) ABSTRACT

A system and method for assessing student performance. The method includes receiving student data, third party data, a set of predetermined thresholds, and an activity guide at a computer processor. The student data and third party data are linked into a collected data, at least a part of which is evaluated against the set of predetermined thresholds. The student's performance is classified based on a determination if the collected data meets the predetermined thresholds. The collected data and classifications are stored and displayed, and a performance score is provided. A targeted strategy is provided for the student by identifying a set of targeted actions corresponding to the student classifications, and displaying targeted actions to authorized users.

### CROSS-REFERENCE TO RELATED APPLICATIONS

This application claims priority to U.S. Provisional Patent Application Ser. No. 61/866,832, filed Aug. 16, 2013, the entirety of which is herein incorporated by reference.

### FIELD

The present disclosure is directed to systems and methods of analyzing and predicting student behavior, performance, and success. More specifically, the present disclosure is directed to early warning and recognition for student achievement in schools. Some embodiments of the present disclosure are implemented by the Applicant in a system referred to as “ABCToday”™.

### DESCRIPTION OF THE RELATED ART

Much research has been conducted to identify what makes a great community, and what can be done to foster development of a great community. One model identifies the four pillars that make a great community: educated citizens, safe neighborhoods, healthy families, and a reliable and productive work force. The Applicant of the present disclosure undertook a comprehensive plan to assist in the development of the first pillar—improving student performance to develop more educated citizens. The Applicant partnered with educational professionals, social service organizations and mental health professionals to identify what role a third party provider could play in achieving these goals. As a result, Applicant undertook the task of building a system for tracking student performance, including the development of an effective tracking and evaluation tool, to improve student performance. The tracking tool has built in predictors that could be used to identify where early intervention is required and could reward behavior that leads to more successful students. Through development of the present disclosure, Applicant learned that the model it created to help build the first pillar was instrumental in predicting and achieving the remaining three pillars. Thus, although Applicant's initial efforts were dedicated to evaluating student achievement in the classroom, Applicant's present model is a predictor to the achievement of all four pillars and therefore has the ability to become a “community vital sign.”

The success of students is a top priority of every education system. Various prior art methods have been employed to identify and quantize student success. In order to implement these prior art methods, a vast amount of educational and non-educational data is collected in various formats. The sheer volume of available data and formats, however, created a data management issue that overwhelmed the available resources. As a result, most of the collected data remained unanalyzed, and only test scores are routinely used to provide a “measure” of the success of students. However, test results are an after-the-fact metric which does not provide sufficient information in a timely fashion to provide early intervention services to students who require assistance. Also, test scores have traditionally been used to track “success” of individual schools with limited ability to provide meaningful analysis across schools in a district or identify the basis for differences between schools, or for students. Although use of standardized tests is widespread in schools, the test results are generally not understood by parents and, from a student's viewpoint, typically do not have sufficient consequences or accountability associated with them as shown in “What Matters for Staying on-Track and Graduating in Chicago Public High Schools,” by Easton and Allensworth, and “On Track for Success,” from the Civic Enterprises & The Everyone Graduates Center at Johns Hopkins University. It is also believed, that standardized tests and IQ scores are not the best predictors for graduating from high school, receiving a postsecondary degree or becoming a productive adult.

There exists a need to provide early and meaningful evaluation, intervention and recognition of the success and progress of students, schools and school districts.

### SUMMARY

The present disclosure provides a way to collect a vast amount of real-time data, streamline it, organize it, and simplify it, so that is can provide metrics which can be used to track the progress of students and provide targeted actions to intervene or recognize student performance. In one aspect, the present disclosure collects and tracks student data related to attendance, behavior, and classroom performance in reading and math, what the Applicant has referred to in ABCToday as “ABC” data. For example, attendance, discipline, referrals, and reading and math grades can be collected for the students and evaluated against predetermined thresholds to identify the successes, risks, and the progress that a student is making. Because of educational and privacy laws and regulations, agreements with parents and schools consenting to the collection and use of the data may be required.

The evaluated data is particularly useful for a partnering relationship between the school, the student, and mentoring partnering programs, such as Big Brothers Big Sisters. On a periodic basis, the evaluated data can be reviewed with school officials and individual students, parents and mentors, to identify early intervention strategies when necessary, and to recognize and reward success of achievement goals. In some embodiments the detailed process to review and respond to data on a regular basis, traditionally quarterly, and is referred to as the “ABCCycle” by the Applicant in ABCToday.

In some embodiments of the present disclosure, a method for assessing student performance is provided. The method includes receiving at a computer processor student data transmitted from an education institution, third party data, a set of predetermined thresholds, and an activity guide containing a list of potential targeted actions. The student data comprises data pertaining to a student's attendance, discipline referrals, and math and reading grades. The student data and third party data are linked into a collected data and stored in a memory device. At least a subset of the collected data is evaluated and classified by determining if the subset meets each of the predetermined thresholds. The classifications of the collected data are stored and displayed with the collected data. A performance score is calculated for the student. Finally, a targeted strategy for the student is provided by identifying a set of targeted actions from the received activity guide based on the student's classification(s), and displaying this list to authorized users.

In some embodiments of the present disclosure, a system for assessing student performance is provided. The system includes a computer processing having a display and memory device for storing student data, third party data, a set of predetermined thresholds, an activity guide, and computer instructions of an evaluation tool. The computer is adapted to execute the evaluation tool, link the student data and third party data and store it as a collected data, evaluate at least a subset of the collected data against the predetermined thresholds by determining if it meets the predetermined thresholds, classify the student's performance based on the determination, and store the classification. The computer is further adapted to provide a performance score for the student, display the collected data and the student's classification(s), and provide a targeted strategy for the student by identifying a set of targeted actions from the received activity guide based on the student's classification(s) and displaying the identified targeted actions to one or more authorized users.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments.

FIG. 1 is a system for assessing student performance according to some embodiments.

FIG. 2 is a flow chart illustrating a computer-implemented method for assessing student performance according to some embodiments.

FIG. 3A-3C are examples of predetermined thresholds according to some embodiments.

FIG. 4 is a display of an evaluation tool according to some embodiments.

FIG. 5 is another display of an evaluation tool according to some embodiments.

FIG. 6 is another display of an evaluation tool according to some embodiments.

FIG. 7 is another display of an evaluation tool according to some embodiments.

FIG. 8 is another display of an evaluation tool according to some embodiments.

FIG. 9 is an index score sheet according to some embodiments.

FIG. 10 is a student performance index according to some embodiments.

FIG. 11 is portion of an activity guide according to some embodiments.

FIG. 12 is another display of an evaluation tool according to some embodiments.

### DETAILED DESCRIPTION OF THE EXAMPLES

With reference to the Figures, where like elements have been given like numerical designations to facilitate an understanding of the drawings, the various embodiments of a systems and methods for early warning and recognition for student achievement in schools are described. The figures are not drawn to scale.

Various embodiments address the foregoing deficiencies of prior art systems and methods for early warning and recognition for student achievement in school by collecting a vast amount of real-time data, streamlining it, organizing it, and simplifying it to provide metrics based on evaluated data which can be used to predict the likelihood of the students' success, provide targeted actions to celebrate student success or interventions to address current or predicted student shortcomings, and track the progress of students before, through the implementation of, and after any intervention. Users benefit from being able to easily and rapidly review a comprehensive analysis of student scholastic and non-scholastic information, define specific thresholds and actions for any particular individual or group, analyze the effectiveness of any responsive action, predict the future performance or behavior of any student, and compare both individual and aggregate data based on home-life factors, school or school district, and participation in mentoring programs or other after school programs.

The following description is provided as an enabling teaching of a representative set of examples. Many changes can be made to the embodiments described herein while still obtaining beneficial results. Some of the desired benefits discussed below can be obtained by selecting some of the features or steps discussed herein without utilizing other features or steps. Accordingly, many modifications and adaptations, as well as subsets of the features and steps described herein are possible and can even be desirable in certain circumstances. Thus, the following description is provided as illustrative and is not limiting.

This description of illustrative embodiments is intended to be read in connection with the accompanying drawings, which are to be considered part of the entire written description. In the description of embodiments disclosed herein, any reference to direction or orientation is merely intended for convenience of description and is not intended in any way to limit the scope of the present disclosure. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that a system or apparatus be constructed or operated in a particular orientation. Terms such as “attached,” “affixed,” “connected” and “interconnected,” refer to a relationship wherein structures are secured or attached to one another either directly or indirectly through intervening structures, as well as both movable or rigid attachments or relationships, unless expressly described otherwise. The term “adjacent” as used herein to describe the relationship between structures/components includes both direct contact between the respective structures/components referenced and the presence of other intervening structures/components between respective structures/components.

As used herein, use of a singular article such as “a,” “an” and “the” is not intended to exclude pluralities of the article's object unless the context clearly and unambiguously dictates otherwise.

The present disclosure allows users to take raw information from disparate systems and transform the information into new data that accurately tracks and predicts the future performance of a student by identifying relationships between the raw data. This newly transformed data can be presented graphically to efficiently convey the evaluation to a user and quickly identify areas of concern. Prior art systems are, at best, repositories for data form disparate sources and do not have the ability to create or identify relationships between the raw data, nor transform the data into new data which the present disclosure uses to track student performance, identify deficiencies and identify interventions.

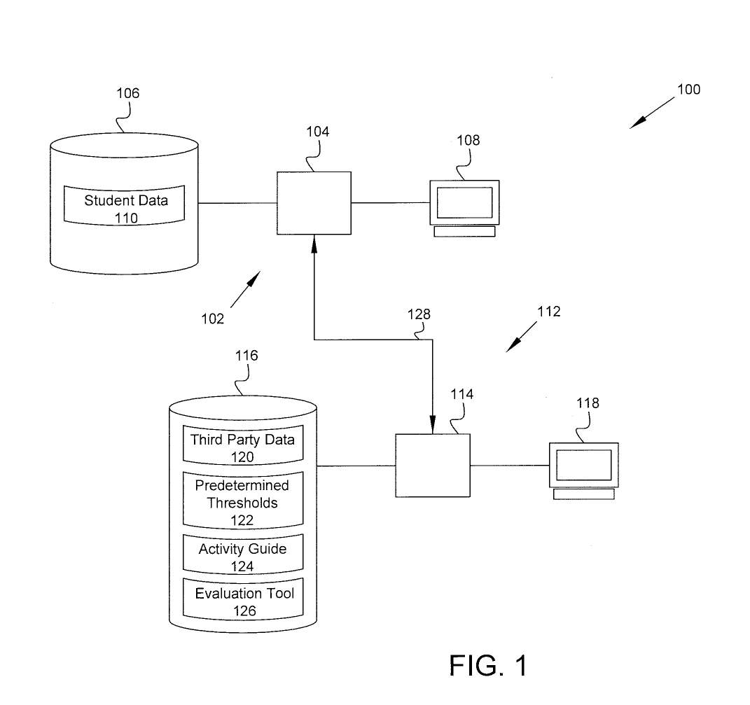

FIG. 1 is an embodiment of a system 100 for assessing student performance. The system 100 comprises a first computer 102, a first computer processor 104, a first memory 106, a first display 108, a second computer 112, a second computer processor 114, a second memory 116, a second display 118, a student data 110, a third party data 120, a set of predetermined thresholds 122, and activity guide 124, and computer instructions for an evaluation tool 126. Computers 102 and 112 may optionally be collocated. In operation, system 100 has student data 110 stored in memory 106, and after receiving student data 110 at the second computer, memory 116. Further, the system 100 has third party data 120 stored in memory 116, a set of predetermined thresholds 122 stored in memory 116, an activity guide 124 stored in memory 116, and a computer instructions of an evaluation tool 126 stored in memory 116. Computers 102 and 112 operably connected to each other by connection 128 for example, by a direct network connection such as a Local Arena Network or remotely, via the Internet or other longer distance connection. Computer 102 provides the student data 110 to computer 112. The computer 112 contains the activity guide 124 and the set of predetermined thresholds 122 stored in memory 116. In some embodiments, the computer processor 114 receives the predetermined thresholds 122 from first computer 102. In some embodiments, the computer processor 114 receives the activity guide 124 from the first computer 102. In various embodiments, the first computer 102 is associated with more than one institution. In some embodiments, the second computer 112 is associated with more than one organization. In various embodiments, one or more of computers 102 and 112 are more than one computer, and may be maintained at locations according to the particular needs of a deployment, including at an educational institution or at a third party organization, such as Big Brothers Big Sisters.

The first computer 102 supplies the student data 110 for subsequent processing. In some embodiments the first computer 102 is associated with an educational institution that is a private or public school. In other embodiments, the educational institution is a school district. It yet other embodiments, the educational institution is any organization capable of providing student data 110. Student data 110 can be provided via wired or wireless transmission, or may be transferred in the form of a CD-ROM, CD-R, CD-RW, thumb drive, floppy drive, portable hard drive, or other permanent storage device that is useable to electronically transfer data from computer 102 to computer 112, each of which is generally referred to as a “transmission” herein.

In some embodiments, a third computer associated with a third party organization supplies the third party data 120 for subsequent processing by the second computer 112. In various embodiments, the third party organization is a mentoring program such as Big Brothers Big Sisters. In some embodiments the third party organization is a health care organization. The third party organization may also be a non-profit organization, or an educational institution which has collected the necessary information to supply the third party data 120. The third party data 120 can be provided via any form of transmission.

In some embodiments, the student data 110 is any data related to individual students collected from an educational institution, including data related to a student's attendance, discipline referrals, and math and reading grades. In other embodiments, the student data 110 also includes data related to a student's tardies. In various embodiments the student data 110 contains data for multiple students. In order to comply with applicable education and privacy requirements, it may be necessary to implement special handling requirements for the collected student data 110. Receiving the student data 110 may be subject to consent forms from parents, it may be encrypted, and identifying information may be redacted or encoded to allow less restricted use without divulging personal identifying data. In some embodiments, the student data 110 is collected, transmitted, and received at the completion of specific periods, such as an academic quarter. In some embodiments, the student data 110 is gathered during or after the completion of other grading periods such as a semester or other period. Student data may also be collected from earlier periods. Historical student data is data from any period prior to the student's placement in the evaluation system. Various embodiments collect student data 110 from both current and historical periods in order to provide a more complete picture of the student in order to better classify the student, predict the likelihood of the student's success, and to provide more timely and targeted intervention actions.

Information collected about a student includes third party data 120. Such third party data 120 is collected from a third party organization and may be stored on computer 112 or received via a transmission from the first computer 102 or some other computer. In some embodiments, an Agency Information Management (AIM) system, such as that maintained by the Applicant, or other similar information source, may transmit the third party data 120 to the second computer 112. Other sources of third party data 120 may include surveys and may be maintained on a file like an excel spreadsheet on computer 112. In various embodiments, third party data 120 includes information about a student's living situation, household income level, or status of parent's incarceration. The student's living situation—whether the student is living in a foster home, with a grandparent(s) or other relative(s), in a one-parent home, with a guardian or other parental situation, or is homeless—may be integrated to aid in classifying the student, predicting the likelihood of the student's success, and providing timely and target intervention actions. The third party data 120 can include data on the rate of mobility of the student, the length of time of a match between the student and a mentor, a quantification representing the quality of relationship between the student and mentor, and the age of the student. The rate of mobility of a student is the frequency at which a student moves either to a new residence or to a new school. Moving to a new residence often necessitates moving between school districts and can create difficulty for students in forming lasting relationship with peers, mentors and authority figures. Similarly, a student's age can have a significant impact on the selected targeted strategy selected for that student. In some embodiments, the length of time of a match between a student and mentor is automatically calculated upon receiving a match start date. In some embodiments, the quality of the relationship between a student and mentor is entered as the subjective determination of a mentor or the mentor's supervisor. In some embodiments, such as the Applicant's ABCToday system, these relationships are quantified into three levels: a true relationship visually represented by the color green; a developing relationship (yellow); and, a struggling relationship (red). In some embodiments the third party data 120 further comprises mentor data. Mentor data includes a variety of information related to a mentor such as the mentor's age, married status, ethnicity, employer, match status (or the student's institutional affiliation), and gender. In other embodiments, socio-economic factors, participation in mentoring or after school programs, and mentor information may be included in the third party data 120. Other third party data 120 can include the student's access to basic resources such as the quality and quantity of available food and water, the status of shelter and housing and other resources such as electricity or internet access, and health care resources. Third party data 120 can further include a student's health data collected and shared with the consent of the parent. It might also include the identification of non-cognitive skills of the student that can be tracked and added to the system to further assist with predicting a student's success in school and beyond, the results of standardized tests such as the SAT, ACT, or state or other administered test, as well as the student's involvement in mentoring or other afterschool programs. Examples of these programs can include, but is not limited to, College Bound, College Summit, Read to Succeed, and Blue Print tutors. In the typical prior art systems for evaluating student achievement, only data that existed in the public school databases was utilized with no capability or capacity to automatically merge that data with the data maintained by a third party organization, severely limiting the ability of prior art systems to evaluate relevant data, accurately predict the likelihood of student success in school, and identify the appropriate actions.

For each type of data 110 and 120 that is collected, a set predetermined thresholds 122 can be received or set, which can then be used to track success and identify areas where intervention is required or rewards are warranted. In some embodiments, multiple predetermined thresholds 122 can be established for each type of data 110 and 120 and appropriate intervention and reward activities can be identified for each predetermined threshold of the set 122. In some embodiments, the predetermined thresholds 122 are those corresponding to a subset of collected data 110 and 120. Unlike prior art models which may have used one dimensional parameters, various embodiments of the present disclosure takes into account multiple facts directed to attendance, behavior, class room goals in reading and math, and other third party data 120 to track a student's progress and recommend a strategy for interacting with the student positively. For example, it has been said that if a student misses more than twenty days of school (called the attendance cliff) it is unlikely that the student will be able to meet his or her educational requirements, for example, as described in “On Track for success,” by Civic Enterprises & Everyone Graduates Center at Johns Hopkins University and “Destination Graduation,” by the Baltimore Education Research Consortium. Thus, in one sense, success was defined in the prior art as a student who misses less than 20 days of school. In some embodiments a predetermined threshold 122 for attendance is much lower than 20 days. This allows the evaluation tool to identify a situation in which an attendance intervention is required well before a student reaches a point at which success is unlikely to occur. In other embodiments, multiple predetermined thresholds 122 for attendance may be set. For example, a student may be classified as succeeding in attendance by having less than 3 absences in any quarter, in addition to cumulative thresholds such as less than 5 absences over two quarters, less than 8 absences over three quarters, and less than 10 absences over the course of a school year (a cumulative data threshold). An additional threshold may be used in which 3 or more absences in any quarter, regardless of the student's absences in a previous period, warrants intervention (a current data threshold). Another threshold may require improvement over a previous period, such as reducing the number of absences, or maintaining them at zero or some other level (a data trend threshold). The use of these types of thresholds—a current data threshold, a cumulative data threshold, and a data trend threshold—allows the processing and evaluation of raw data from separate sources, transforming it into new data that tracks and predicts student performance. The use of similar tiered and/or multiple thresholds for any data type 110 and 120 can aid in better classifying the student, predicting the likelihood of the student's success, and providing more timely and targeted intervention actions.

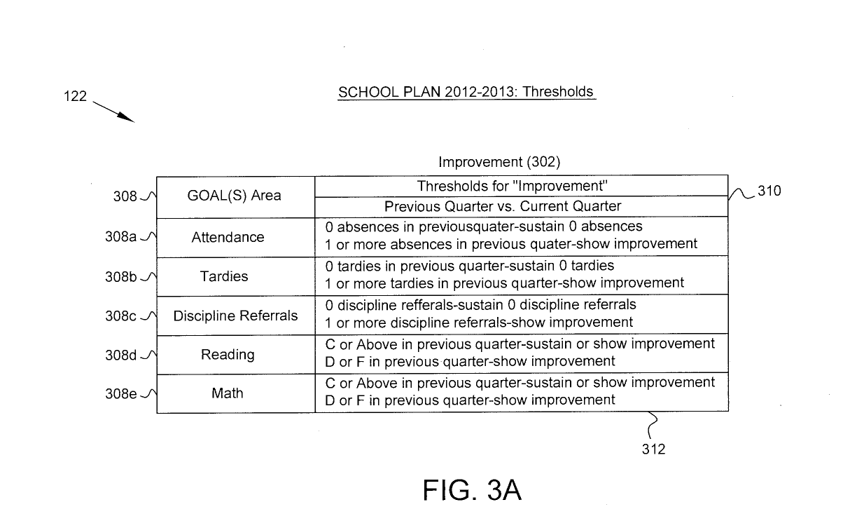

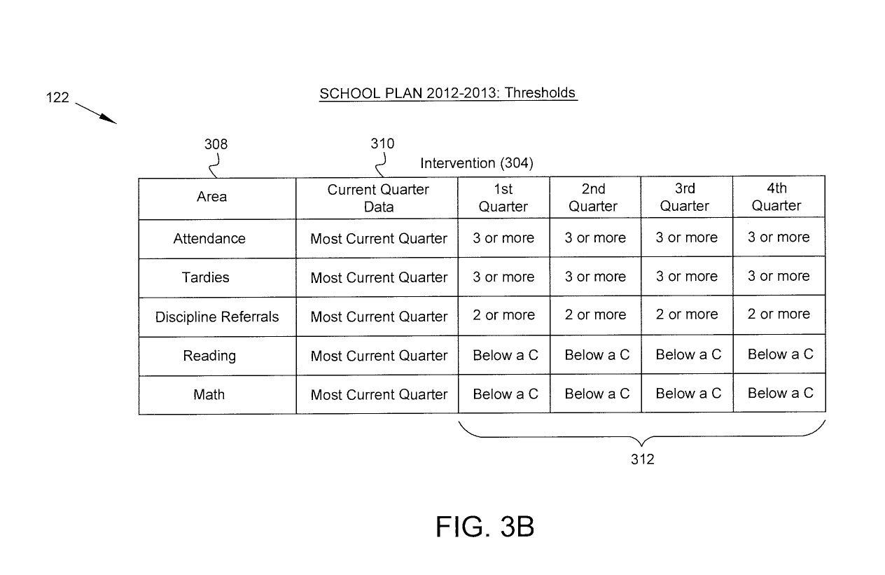

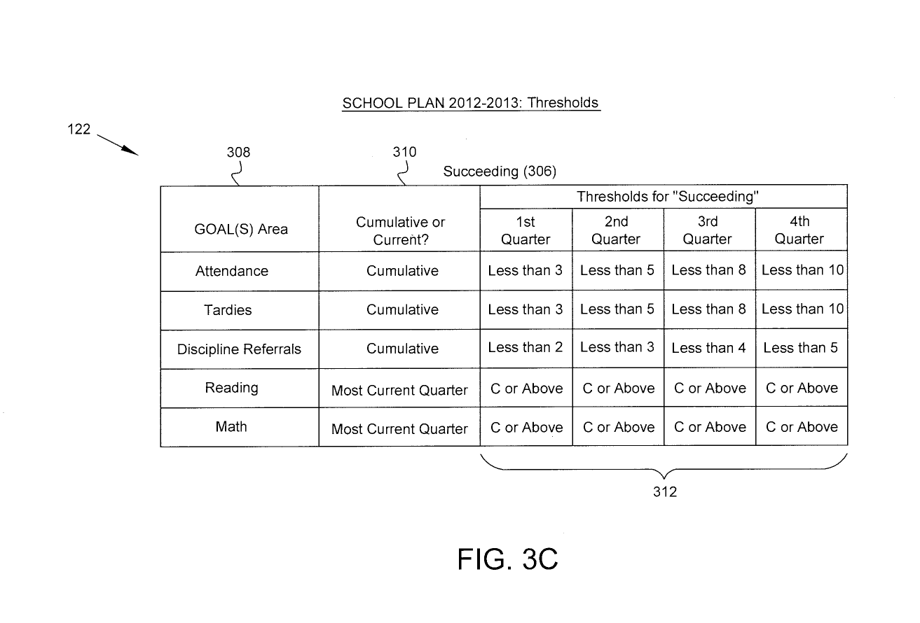

FIG. 3A-3C represents one embodiment of tired set of multiple predetermined thresholds 122 that may be established in the areas of attendance, tardies, discipline referrals, reading and math. In this embodiment, the thresholds are tiered, with different thresholds categories for students classified as “succeeding” 306, “intervention” 304 and “improvement” 302 (for students showing improvement or sustaining success as compared to the prior evaluation period). While three classifications are provided in the embodiment shown in FIG. 3A-3C, any number of classifications may be defined by the user. Each threshold classification 302, 304, and 306 contains a goal area 308, a period for evaluation 310, and a thresholds 312. In some embodiments, the goal area 308 can be comprised of any type of collected data 110 and 120. As shown in FIG. 3A, the example goal areas are Attendance 308a, Tardies 308b, Discipline Referrals 308c, and Reading 308d and Math 308e grades. Each goal area 308a-308e has a defined evaluation period 310 for each of the student classifications 302, 304 and 306. FIG. 3A-3C illustrates examples of evaluation periods 310. For the improvement classification 302, the evaluation period 310 requires a comparison of current and previous quarters collected data (a data trend). For the intervention classification 304 listed in FIG. 3B, only data from the current quarter is evaluated (current data). In some embodiments, the data periods 310 for the intervention Classification 304 can cover cumulative periods, or a mix of cumulative and current quarters. A mix of cumulative and current quarter periods are used for the evaluation period 310 for the succeeding classification 306 (cumulative data and current data). Here, the cumulative period may be from the beginning of the school year, from the beginning of the students participating in an afterschool or mentoring program, or may be cumulative over some other period. The thresholds 312 are compared to all collected data 110 and 120 in order to classify a student as succeeding 306, intervening 304, or improving 302.

In various embodiments, the thresholds 312 are the those in the preferred embodiment illustrated in FIG. 3A-3C. In other embodiments, the thresholds 312, goal areas 308, and evaluation period 310 may be customizable and may be adjusted by the user. In many embodiments, users of the evaluation tool 126 can modify the set of predetermined thresholds 122 to customize them for a student, school, school district, or other group of students. For instance, in some embodiments a user may add additional goal areas 308. In some embodiments the user may change the evaluation period 310 from either current or cumulative or trending types. In many embodiments the user may adjust the individual thresholds 312 after the evaluation of new or updated data 110 and 120. In various embodiments an updated set of predetermined thresholds 122 may be received.

Various embodiments included tiered thresholds 312 directed to third-party data 120. For example, the quality of a mentoring relationship may be categorized as a true relationship, a developing relationship, or a struggling relationship, and may be color coded as green, yellow, or red, respectively. In some embodiments, third-party data thresholds may include the length of match between any mentor/mentee such as less than 6 months, up to one year, or over one year in length. Other thresholds can be created for household income level, the age of the student, the age of a student's mentor, or any type of collected third party data 120.

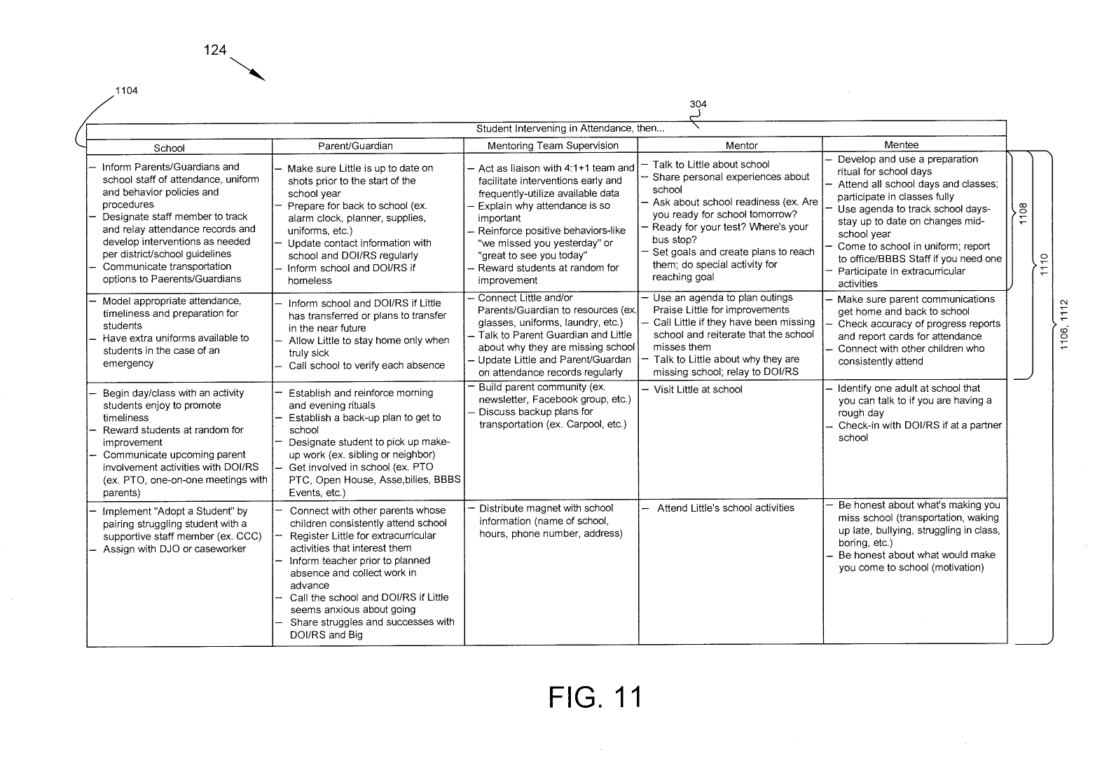

FIG. 11 illustrates one embodiment of a portion of an activity guide 124. In this example, a plurality of potential targeted actions 1106 are listed by specific individuals 1104 in a student's life when the student is classified as intervening 304 for failing to meet an attendance threshold. These individuals 1104 include school personnel, the student's parent or guardian, a mentoring team supervisor, the student's mentor, and the student. In the Applicant's ABCToday system the mentoring team supervisor is known as a “Director of Impact/Relationship Specialist” (DOI/RS), a student's mentor as a “Big,” and the student as a “Little.” For example, for a student struggling in attendance, the target intervention may be to established daily rituals and to identify barriers (i.e. lack of transportation, uniforms, school supplies) and identify resources parents can use to minimize or eliminate the barriers. Other strategies may include coaching mentors on working with the student to set attendance goals, creating a plan to reach these goals and celebrate successes and follow up by checking attendance daily, calling parents if the child misses school, and getting regular feedback from parents, mentors, and teachers. On a wider level, the evaluated results can be used to develop school wide initiatives with celebrations for meeting a threshold, such as a classroom pizza party.

The activity guide 124 is imported into the computer 112 and used by the evaluation tool 126. The activity guide 124 comprises a set of targeted actions 1106 (interventions, rewards, and recognition activities) based on the student's classification for the types of the collected data 110 and 120. This allows the evaluation tool 126 to select the correct set of targeted actions 1106 when a student fails to meet a given threshold 312. Conversely, the guide may include recommended actions to take to recognize a student who successfully meets other thresholds and is classified as succeeding 306 or improving 302.

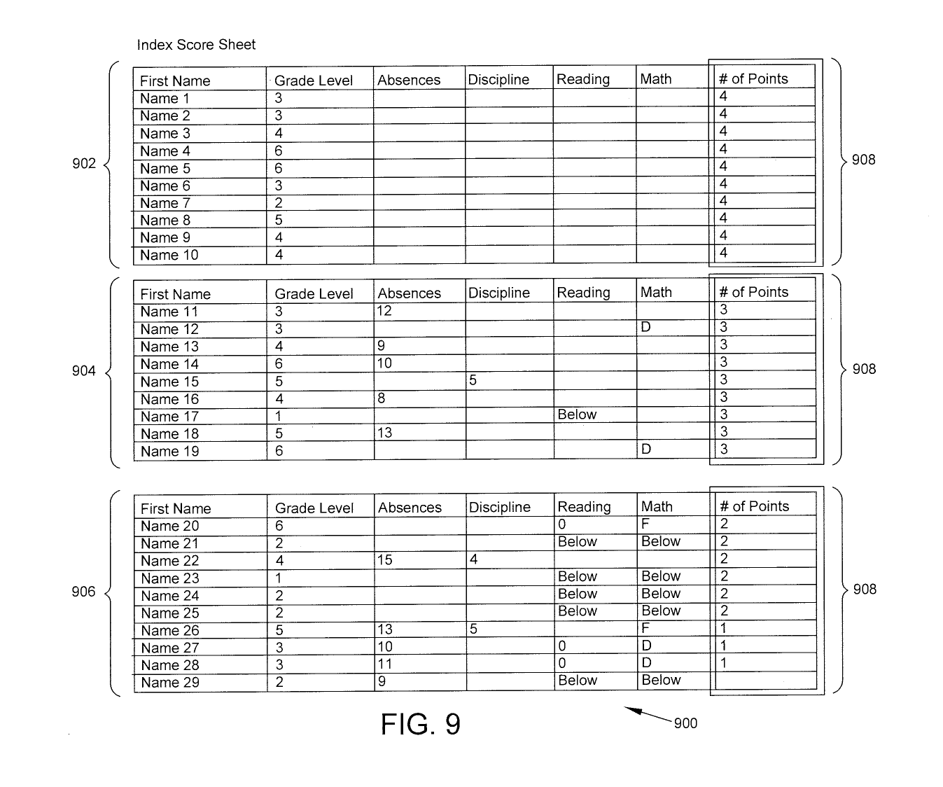

The targeted actions 1106 of the activity guide 124 can be further divided. In some embodiments, the targeted actions 1106 are divided based on a student's performance score 908 (see FIG. 9). Different targeted actions 1106 may be warranted depending on the number of categories in which a student is classified as succeeding 306, improving 302, or intervening 304. In some embodiments, the targeted actions 1106 for a student with a higher performance score 908 who is classified as intervening only in attendance, or other singular goal area 308, may be only a subset 1108 of targeted actions 1106. Similarly, the subsets 1110 and 1112 for a student intervening in more than one or half or more categories, respectively, are larger than the subset 1108. In other embodiments, the targeted actions 1106 may be divided by severity of or effort level needed to implement the targeted action 1106, with the more sever or involved actions generally used for students with lower performance scores 908.

In some embodiments, after the evaluation tool has determined a targeted strategy for a student, it will provide each individual a list of targeted actions 1106 to be taken by that individual. The evaluation tool 126 determines a user's status or relationship to a student is determined by a user's login authentication. After entering a user name and password, the individual can be presented with his targeted actions 1106 from the targeted strategy. The authorized user may modify the presented targeted actions 1106. This modification will be both displayed to any affected authorized users and stored in the second memory 116. In other embodiments, the targeted actions 1106 for all users will be presented to any user. In some embodiments, the targeted actions 1106 are transmitted and displayed to the respective individual, such as the parent, teacher, and mentor. In other embodiments, targeted actions 1106 are automatically generated by the evaluation tool 126, but are then reviewed and approved by one or more users prior to distribution to other users.

FIG. 9 shows an embodiment of performance index score sheet 900. Performance score index sheet 900 is divided into three sections based on performance score 908. Performance score 908 is calculated by summing the number of goal areas 308 in which a student is classified as succeeding. Students with a score of 4 are grouped into subset 902. Students with a score of 3 are grouped into subset 904. Students with a score of less than 3 are grouped into subset 906.

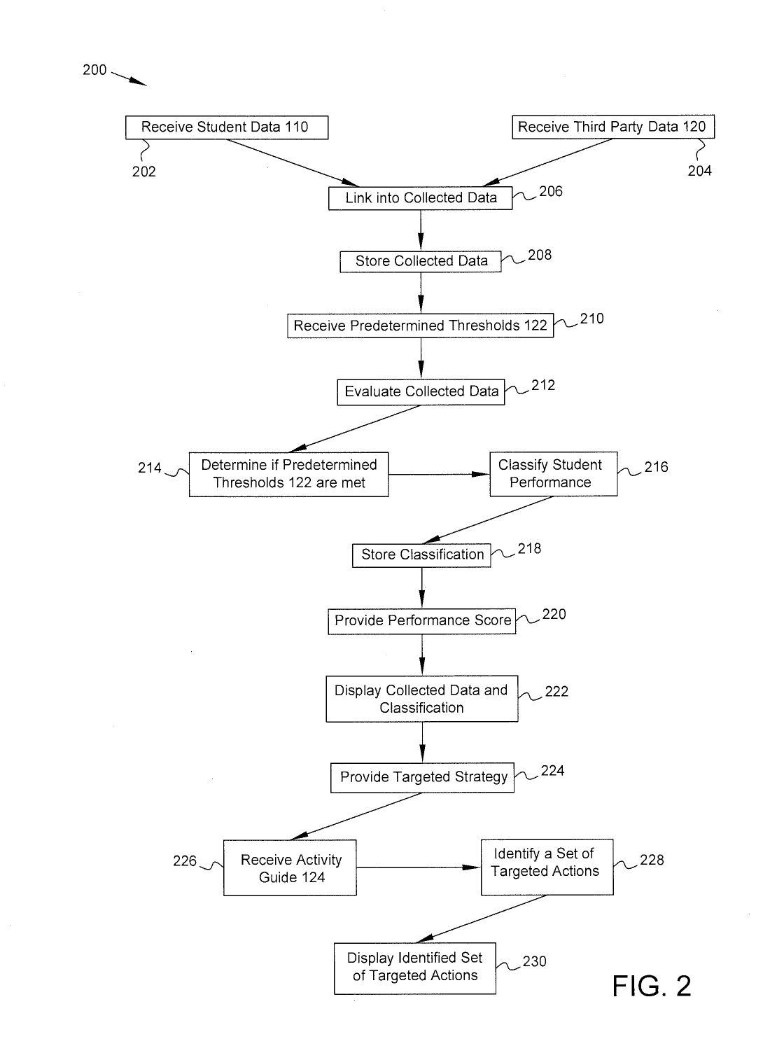

FIG. 2 shows a flow chart illustrating a computer-implemented method 200 for assessing student performance according to some embodiments. At step 202, student data 110 from the first computer 102 is received at the computer processor 114 of the second computer 112. Next, the third party data 120 is received at the computer processor 114. Once the student data 110 and third party data 120 are received, the data 110 and 120 are linked into a collected data in step 206.

The collected data is a record of the data collected, scholastic and non-scholastic, related to an individual student. Typical SQL queries can be performed to combine the separated student data 110 and third party data 120 after it is received. In some embodiments, this linking is performed by migrating third party data 120 into student data 110, migrating student data 110 into third party data 120, or migrating student and third party data 110 and 120 into a new database record. In some embodiments, the student data 110 and third party data 120 are maintained as separate tables and a key is used to associate the tables. This key may be established by student name, school, student ID, social security number, or any other unique identifier common to both data sets 110 and 120. By combining or relating the records, the evaluation tool is able to evaluate, analyze, and display all collected data for a student, thereby providing better, earlier predictions of situations which may require intervention.

At step 208 the collected data record is stored in a memory device 116. The set of predetermined thresholds 122 are received at the computer processor 114 in step 210. The collected data is next evaluated against the set of predetermined thresholds 122 at step 212. This evaluation may be performed for all or a subset of the collected data depending on the received predetermined thresholds 122. The evaluation step 212 comprises determining whether the collected data meets each predetermined threshold 122, and classifying the subset as succeeding 306, intervening 304, or improving 302 dependent on which predetermined threshold 122 is met. This classification (302, 304, or 306) is stored in each record of the collected data at step 218 in memory device 116. The evaluation tool 126 then calculates a performance score 908 as previously discussed at step 220. At step 222, the evaluation tool displays the collected data and the classification of the collected data. The final major step 224 of this method according to one embodiment is to provide a targeted strategy. Step 224 consists of three subsets steps 226-230. At step 226, the activity guide 124 is received at the computer processor 114. Next, the evaluation tool 126 identifies a set of targeted actions from the activity guide 124 based on the student's classification (302, 304, or 306) for each of the collected data. Finally, step 230 concludes the process by displaying the ranked set of targeted actions.

The evaluation tool 126 can rank each targeted action 1106 from the activity guide 124 for each type of data 110 and 120 to provide a targeted strategy for each student. Many different methods of ranking the activities may be used. In some embodiments the actions may be ranked based on a logical order for performing targeted actions 1106. For instance, if a student consistently misses school and performs poorly in the classroom, the targeted strategy may direct actions toward ensuring the students attendance before other activities such as tutoring. In some embodiments, the magnitude of the discrepancy between student and third party data 110 and 120 and the predetermined threshold 122 determines which actions should be ranked higher. Selecting targeted actions 1106 based on the magnitude of discrepancy would preferentially directed efforts to areas where the biggest impact can be made first. In various embodiments, similar or identical types of targeted actions 1106 may exist in multiple the goal areas 308 of the evaluated data. In some embodiments, the frequency of these common intervention actions determines the rank order of activities, with higher frequency being ranked higher, or a subjective determination of the user may select actions based on perceived importance. In some embodiments a combination of these and other rankings methods may be used.

In other embodiments, the evaluation tool may evaluate the effectiveness of each targeted action 1106 as employed over time. For example, actions 1106 taken to address a shortcoming are correlated to the collected data and trends in the collected data across a spectrum of students. The number of instances in which a targeted action 1106 was employed is easily compared to the number of instances in which that action 1106 is followed by an improving trend or reversal of a previous failure. Actions 1106 with higher ratios of improvement to the number of times that action 1106 is taken are ranked higher than those with lower ratios. In some embodiments, this ranking is combined with other ranking methods to provide a targeted strategy customized for each student.

In some embodiments, the method 200 further comprises periodically evaluating updated data to track the progress of the students. In some embodiments, once the data is collected, typical SQL queries can be used to import the data in the applicant's evaluation tool. In various embodiments, the collected data is analyzed to determine if the collected data is greater than, less than, or equal to thresholds 312. The collected data is then classified based on the results of this analysis. In some embodiments, this comparison is performed for data only from the most recent quarter. Many embodiments will also perform a similar evaluation between data sets from different quarters to identify, evaluate, and classify trends in the data. The data trends are then compared to thresholds 312 to provide an additional layer of analysis by evaluation tool 126 in order to more completely classify a student, better predict the likelihood of a student's future success, and provide better targeted intervention activities.

With the collected data classified based on the above evaluation, some embodiments provide for a visual representation of this classification by color coding the collected data for each student. In some embodiments, students who successfully meet or exceed thresholds 312 (for instance, have the same or higher math or reading grade, or the maximum or fewer than maximum number of allowable absences), the evaluation tool may highlight the data green, indicating an area of either lesser or no concern. Likewise, for students failing to meet established thresholds, the applicable student data may be highlighted red. In some embodiments different colors or a series of different colors are used in order to emphasis the extent by which a student does or does not meet thresholds. Various embodiments employ color schemes to indicate the status of trends in the data. For example, a student may over a series of quarters meet the absence threshold in each quarter to be classified as succeeding 306, yet have missed more absences in this quarter than in the previous. This data could be highlighted yellow to identify a negative trend or a student's failure to meet improvement classification 302. Other colors may also be highlighted yellow to indicate when a student classified as succeeding 306 is on the cusp of falling into an intervention 304 classification. For instance, if the student has a “C” in reading or math, has accumulated 2 absences, or a discipline referral in a single quarter the data may be highlighted yellow to emphasis this near miss.

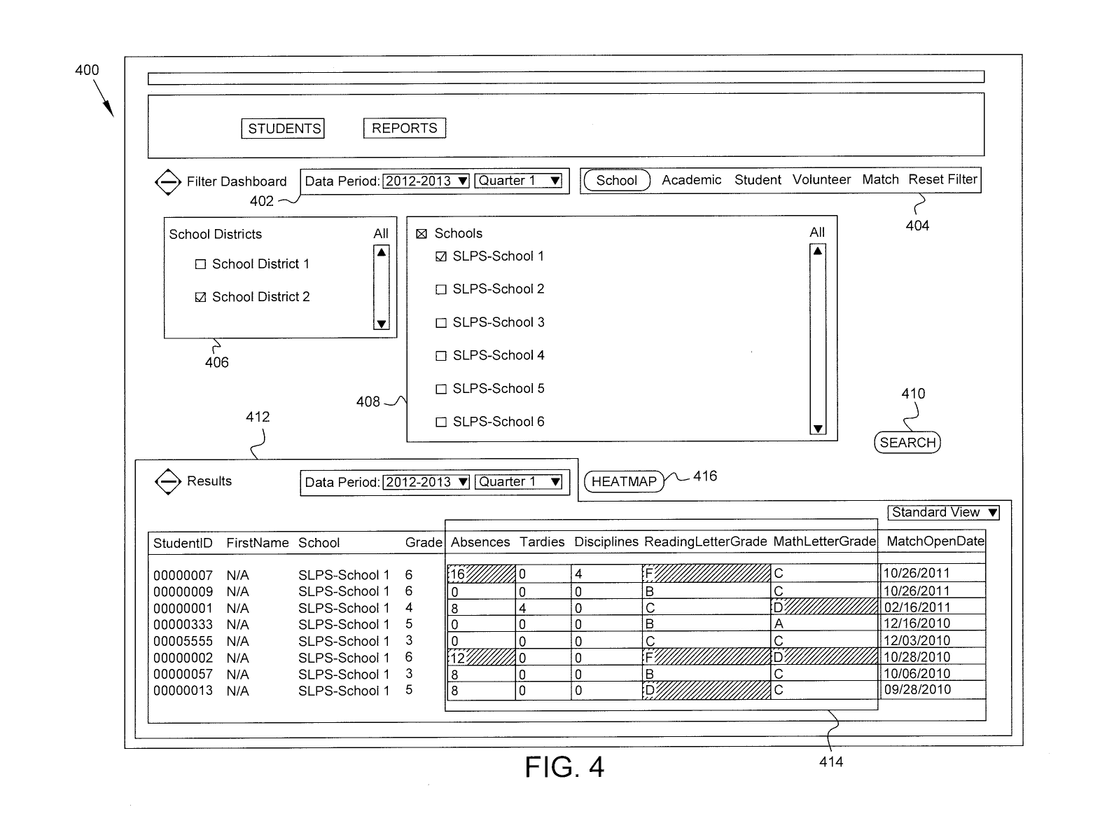

The data can be presented using color coded displays with full functioning filtering and drill down technology. FIGS. 4-8, shows several embodiments of the displayed results from an evaluation and classification of the data. FIG. 4 illustrates how the data can be presented by school, by district, and by student for each of the captured data for absences, tardies, discipline, and reading and math grades. The data can be presented in a tabular form using a “heat map” having different colors to identify parameters that fail to meet or exceed thresholds as described above. With reference to FIG. 4, the display 400 contains a data period 402, a display selection 404, filtering criteria 406 and 408, a search button 410, results 412 which include the collected data and evaluated data 414, and a heat map button 416. The data period 402 and display selection 404 are selected by the user for whatever time period he wishes to see, and in what format. Upon hitting the search button 410, the user is presented the unfiltered results 412 as well as a series of filtering criteria 406 and 408 to limit the displayed results 412. As can be seen in FIG. 4, the user has selected to view the school display, which produces options to filter by district 406 and by school 408. The results 412 contains all or a selected portion of the collected data, and is sortable by clicking on any column heading. Individual students can also be searched for by name or student ID number. Collected data which has been evaluation appears as evaluated data 414. When a user clicks the heatmap button 416, the evaluated data 414 is colored based on its classification. In some embodiments, the color coding displayed when the heatmap button 416 is selected draws the viewer's attention to areas in which the student is improving 302, succeeding 306, or intervening 304. In the preferred embodiment, heat map colors are determined by the classification of the collected data and the period selected 402. For example, if one quarter is chosen, the absence or tardy data will be highlighted red if there are three or more in that quarter, the discipline data if there are two or more, and any math and reading grade less than a C. If two quarters are chosen, the absence or tardy data will be highlighted red if there are five or more in those quarters, the discipline data if there are three or more, and any math and reading grade less than a C. If three quarters are chosen, the absence or tardy data will be highlighted red if there are eight or more in those quarters, the discipline data if there are four or more, and any math and reading grade less than a C. If an entire year is chosen, the absence or tardy data will be highlighted red if there are ten or more in that year, the discipline data if there are five or more, and any math and reading grade less than a C. Otherwise, the data is highlighted green.

Other display selection 404 options include displaying academics, student, mentor/volunteer, and by students matched with a volunteer/mentor. Each display selection 404 contains filtering criteria related to that display. While two filtering criteria are shown in FIG. 4, any number of filtering criteria can be used. Additionally, each display 404 provides a selected portion of the collected data as well as the evaluated data. The different display's filters, however, allow a user to filter through data in many, flexible ways, which aids in analyzing and predicting student behavior, performance, and success and in identifying root causes of student issues.

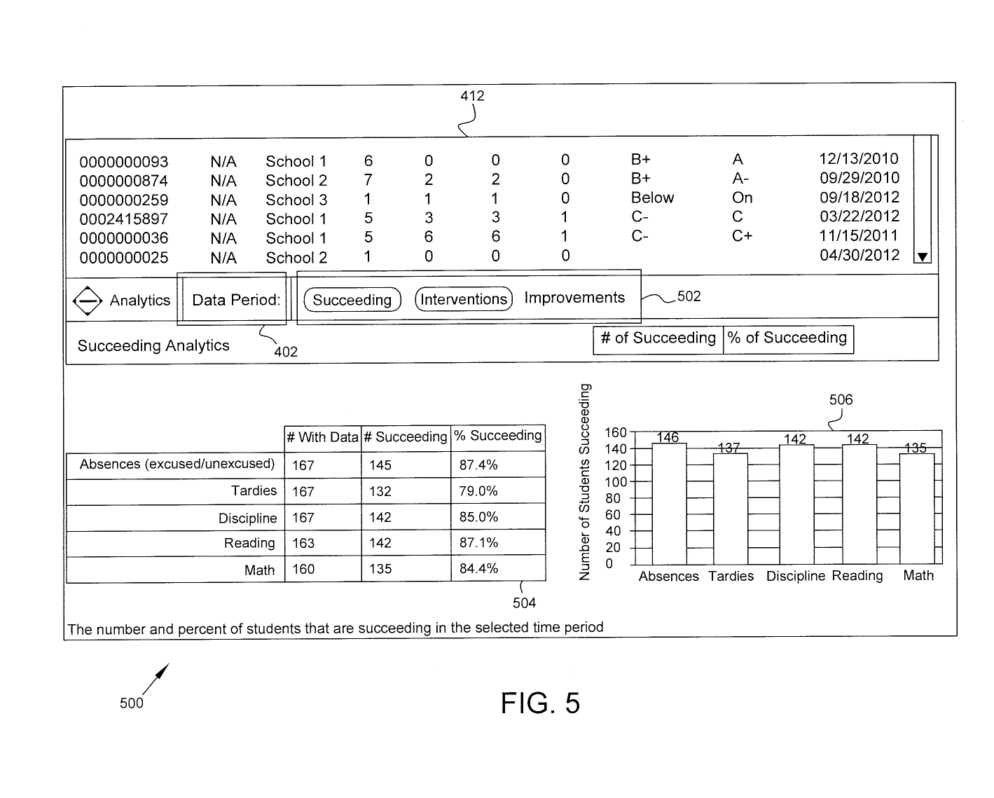

For each performed search, analytics can be provided as illustrated in FIG. 5. As can be seen in FIG. 5, the analytics 500 provide both a graphical 506 and textual 504 representation of all students in each classification (302, 304, and 306). Additionally, the analytics display 500 provides the search results 412, the data period 402, and a classification selection group 502. The classification selection group 502 allows the user to select which classification, succeeding 306, intervening 304, and improving 302 (shown in FIG. 5 as improvements) is displayed.

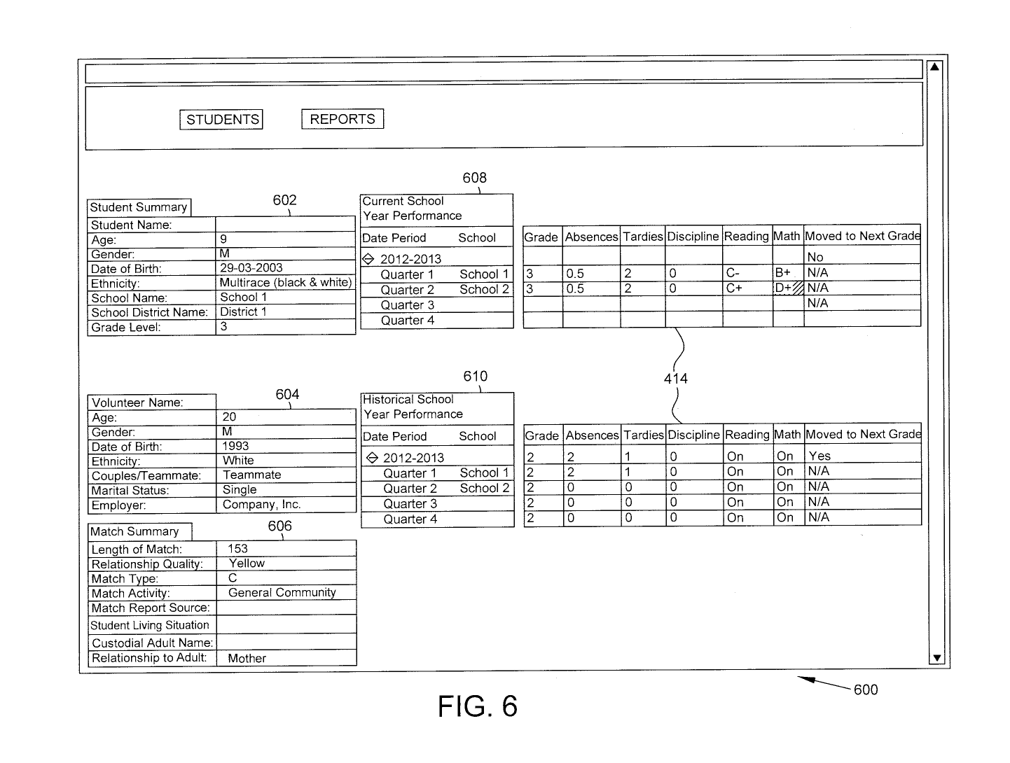

By clicking on any of the individual student records in the results 412, the user will be brought to the individual student detail display 600 as illustrated in FIG. 6. The individual student detail display 600 contains a student summary 602, volunteer summary 604, match summary 606 and evaluated data 414 for the current school year 608 and any historical school year(s) 610. The data supplied in summaries 602, 604, and 606 is that provided in the student data 110 and/or the third party data 120. The student detail display 600 allows the user to readily view an individual's student comprehensive record for both data.

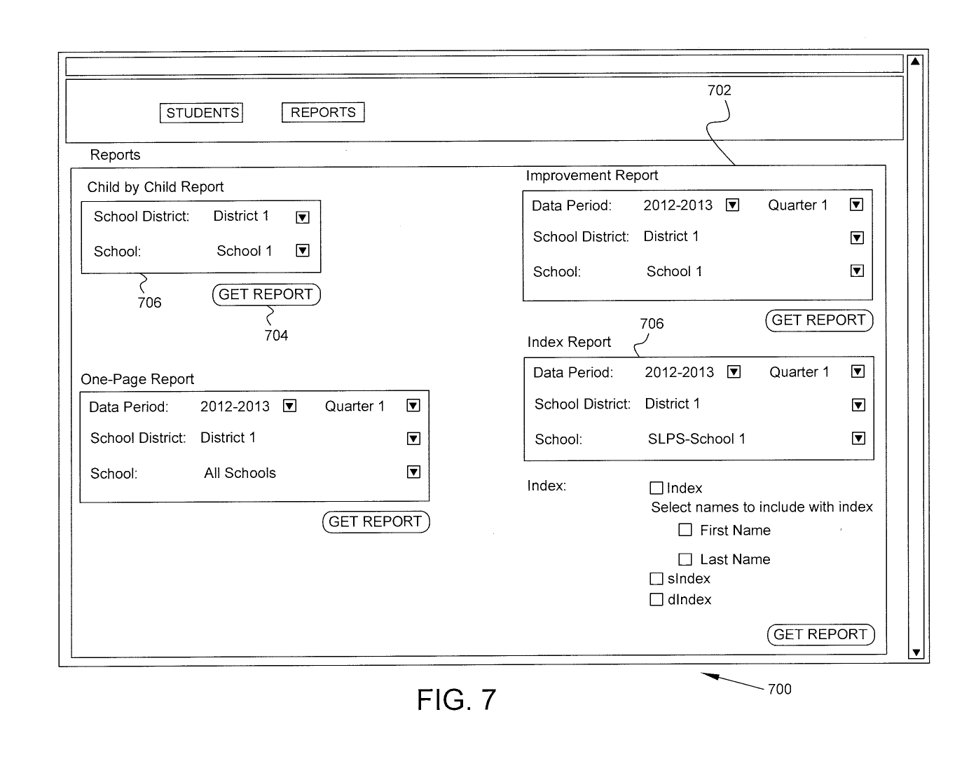

In addition to allowing users the ability to filter and sort the evaluated and classified data, some embodiments use this data to generate preformatted reports. FIG. 7 illustrates one embodiment of a user interface 700 allowing the user to select various types of reports As shown in FIG. 7, the user can select from a series of reports 702 by clicking the get report button 704. In the Applicant's ABCToday system, these reports can include a Child by Child report, and Improvement report, an ABC One-page report, and an ABC Index report. Additionally, each report type contains user-selectable filtering criteria 706 which allow a user to limit the data to be displayed. These limitations may be by school and/or school district, date ranges, status of after-school or mentoring program participating, and other criteria. These reports may be particularly useful when shared with school staff on a periodic basis to review the data and identify struggling students and develop targeted interventions and actions. These newly developed intervention strategies and targeted actions can be incorporated into the evaluation tool 126 and activity guide 124 to be automatically included on future reports and displays.

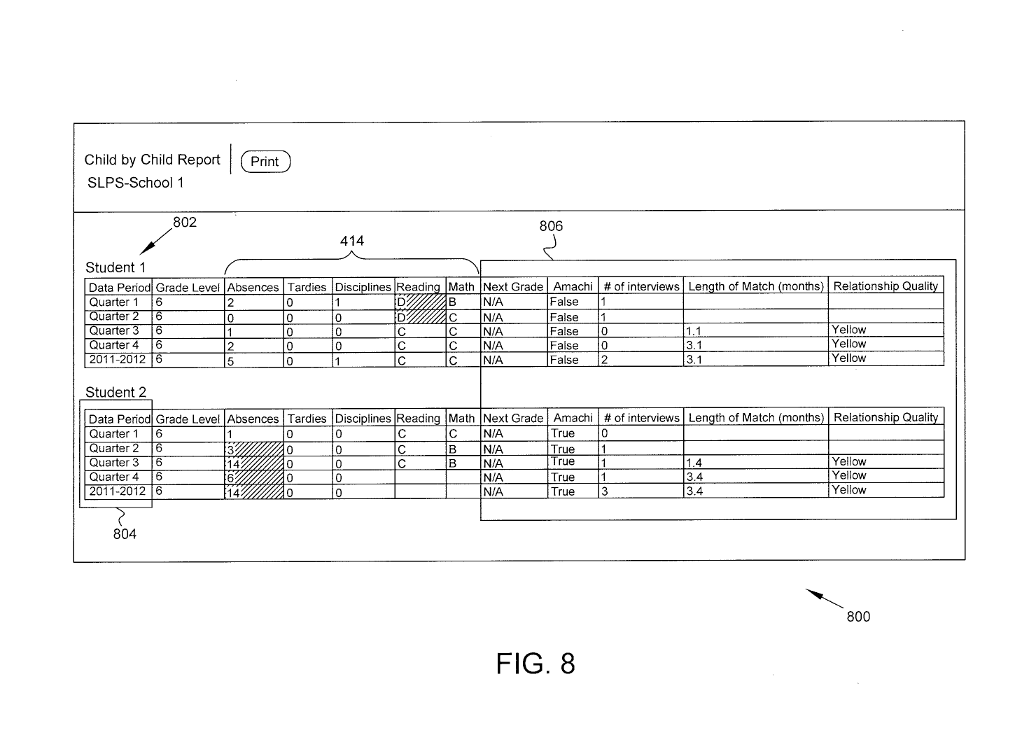

FIG. 8 illustrates one embodiment of a Child by Child report 800. The Child by Child report 800 contains a series of students 802, and data periods 804, evaluated data 414, and other collected data 806 for each student. This report is separated by student, and shows a complete overview of the students' performance during each of the selected data periods 804. The particular students 802 that are displayed result from the user's selection of filtering criteria 706: those students 802 belonging to the school selected during the data period(s) 804 selected will be displayed on the report.

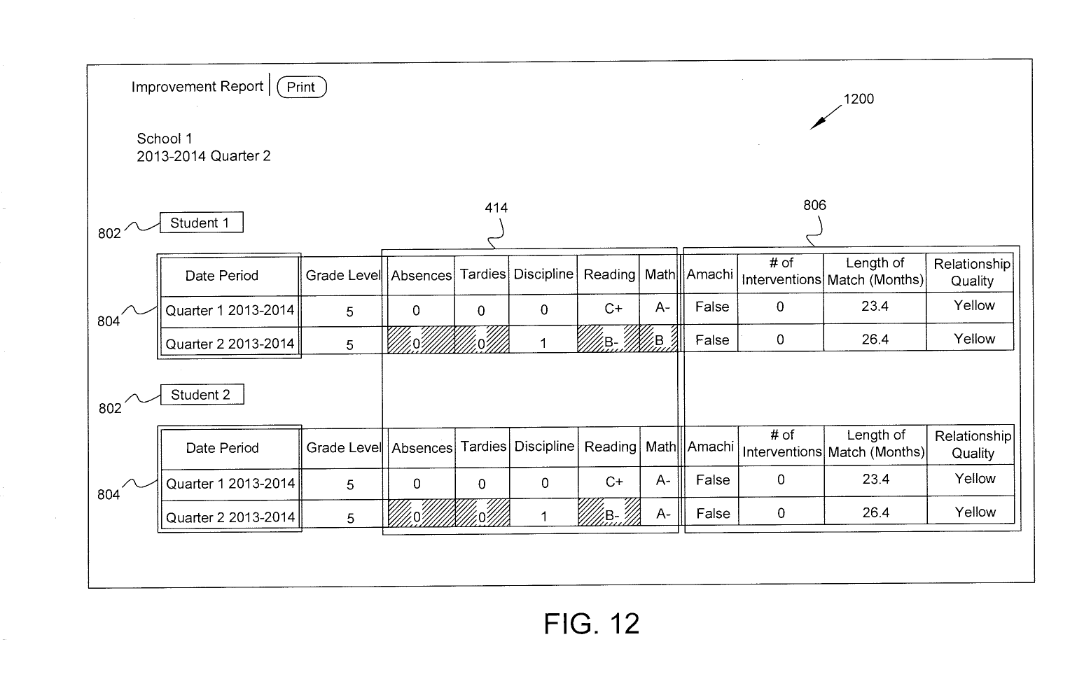

FIG. 12 illustrates one embodiment of an Improvement report 1200. Similar to the Child by Child report 800, collected data and the data's classification is shown for a series of students 802 and during evaluated periods 804. Again, the students belong to the school selected from the filtering criteria 706 on FIG. 7, and any student with data during the selected period will be displayed on the improvement report 1200. This report displays collected data and its post-evaluation classification, particularly for students classified as improving by meeting the improvement 302 thresholds 312. On this report, the collected data is highlighted green for meeting or exceeding these thresholds; otherwise, the data is not highlighted.

In some embodiments, the evaluated data can also be used to create a performance index. In the Applicant's ABCToday system, some embodiments of the performance index are referred to as the ABCIndex. FIG. 9 is one embodiment of a performance score sheet 900 which may be used to create the performance index. Each student receives an performance score 908 in accordance with their compliance for meeting the thresholds for absences, discipline referrals, and math and reading grades. In the ABCToday system, the score is referred to as an ABCScore. If a student satisfies all four thresholds, the student is scored a 4. If the student only satisfies three thresholds, the student is scored a 3, and so on. This total score is a further means to classify a student as a whole, and allows rapid and easy comparisons between varying groups of students. For example, this index may be particularly useful for tracking progress over time for the same school or same district. This index may also be useful in comparing across schools, or across districts.

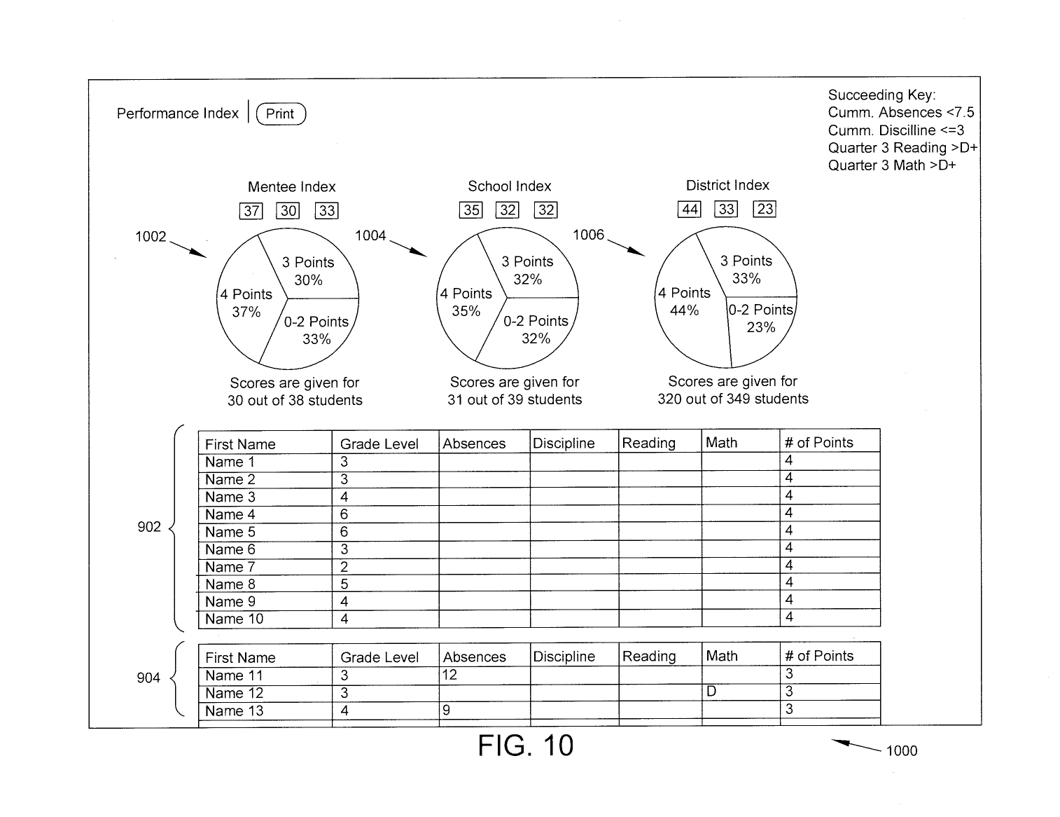

FIG. 10 illustrates one embodiment of various performance indices 1000 for students who participate in a mentoring program 1002, belong to a school 1004, and those that belong to a school district 1006. In the ABCSystem, performance indices 1000 are the LABCIndex (for those student's in the Big Brothers Big Sisters), SABCIndex (for all students in the same school), and the DABCIndex (for all students in the district). Various embodiments produce indices for any of the types of collected data 110 and 120. This allows a rapid and efficient way to correlate the successes or failures of students with other data 110 and 120 such as household income level, access to basic resources, living situation, grade level, after school program affiliation, teacher or other such data. The performance index may be a useful tool to identify which programs work conversely, which programs do not work. It may also assist to identify root causes and provide suggested solutions. For example, and index can be created to track students who participate in a specific after school tutoring program. Over time, this index can be compared to a group of students who did not participate in the tutoring program to provide a measure of the effective of the after school program. There are a broad range of evaluated data that could be indexed in order to measure the effectiveness of in-school and out of school programs, teachers, mentors, etc. While this example discloses four scored categories (absences, discipline, math and reading grades), various embodiments are modified to include a different number of scored types of collected data 110 and 120.

The present disclosure thus provides the many improvements over prior art systems and methods. The Applicant's evaluation tool improves efficiency with both data collection and analysis allowing more accurate and quicker identification of targeted intervention strategies and rewards to address student academic challenges and successes in real time. In addition, the Applicant's evaluation tool simplifies results using a customizable threshold system set district by district, school by school, or student by student. The evaluation tool improves impact and outcomes for students and schools and allows for scalability and replication across school districts in a simple and easy to use format. Users of the Applicant's evaluation tool can readily narrow results and see trends using the filters and sorting system and visually see impact and classifications to see where intervention is needed closer to real time than in prior art systems. The more responsive evaluation tool facilitates early intervention rather than just review at the end of the year. The evaluation tool allows the centralization of all school and all district data, allowing comparisons across students and schools and access to be tool by both school personal (Principals, Superintendents, Counselors, teachers, and other district/school staff) and mentoring organizations. Additionally, the Applicant's evaluation tool provides micro and macro level information to compare across, students, activities and programs, mentors, schools and districts.

The present disclosure can be implemented by a general purpose computer programmed in accordance with the principals discussed herein. It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms data memory including non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVDROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Those skilled in the art will appreciate that the present invention can be practiced by other than the described embodiments, which are presented for the purposes of illustration and not of limitation

What we claim is:

1. A method for assessing student performance comprising:
receiving at a computer processor student data transmitted from an educational institution and pertaining to a student, wherein the student data comprises student attendance data, discipline data, math grade data and reading grade data;
receiving at the computer processor third party data about the student;
linking the student data and the third party data into collected data;
storing the collected data in a memory device;
receiving at the computer processor a set of predetermined thresholds corresponding to at least a subset of the collected data, the subset including at least the student data;
evaluating the subset of collected data against the set of predetermined thresholds, including:
determining whether the subset of collected data meets each predetermined threshold in the set of predetermined thresholds; and
classifying the student's performance into a classification for each of the subset of collected data based on the determination;
storing the classifications in the memory device;
providing a performance score for the student wherein the performance score is based on a combination of the classifications;
displaying the collected data and the classifications for the student; and
providing, by the computer processor, a targeted strategy for the student, wherein providing comprises:
receiving at the computer processor an activity guide, wherein the activity guide comprises a plurality of potential targeted actions, including interventions to improve performance or recognitions to reward performance;
identifying a set of targeted actions corresponding to the classification of the student's performance in at least one type of data in the subset of collected data; and
displaying the identified set of targeted actions to one or more authorized users.

2. The method of claim 1, wherein the identified targeted actions are ranked in order of importance based on said evaluation.

3. The method of claim 2, wherein the ranking is further based on a determination of the most common targeted actions identified for the classification of the student for each type of the subset of collected data, with the most common targeted actions being ranked highest.

4. The method of claim 1, wherein the third party data comprises at least one of household income level data, parent incarceration data, and living situation data describing whether the student is living in a foster home, with a grandparent, with another relative, in a one-parent home, with a guardian, or is homeless.

5. The method of claim 1, wherein the third party data comprises data on a rate of mobility of the student, a length of time of a match between the student and a mentor, a quantification representing the quality of relationship between the student and the mentor, and an age of the student.

6. The method of claim 1, wherein the set of predetermined thresholds comprises:
a current data threshold;
a cumulative data threshold; and
a data trend threshold.

7. The method of claim 1, further comprising:
periodically receiving updated student data and updated third party data about the student;
linking the updated student data and updated third party data into updated collected data;
storing the updated collected data in the memory device;
evaluating the updated collected data to update the classifications, performance score and the targeted strategy.

8. The method of claim 7, further comprising adjusting at least a portion of the set of predetermined thresholds based on the updated collected data.

9. The method of claim 1, wherein the student data further comprises tardiness data.

10. The method of claim 1, further comprising:
receiving an input from an authorized user, modifying a targeted action for a student; and
updating the stored and displayed targeted actions for the student, as modified.

11. The method of claim 1, further comprising:
providing a performance score index for a group of students based on a total number of students in said group that achieve a particular performance score.

12. The method of claim 1, wherein displaying the collected data and the classifications for the student comprises highlighting the collected data based on its classification.

13. The method of claim 12, wherein the set of predetermined thresholds comprises a succeeding threshold for each of the types of said subset of collected data, and wherein the highlighting comprises using a first color in accordance with a color code to highlight whether said student had met the succeeding threshold for each of the types of said subset of collected data.

14. The method of claim 13, wherein the set of predetermined thresholds further comprises a data trend threshold for each of the types of said subset of collected data, and wherein the highlighting further comprises using a second color in accordance with said color code to highlight whether said student had met the data trend threshold for each of the types of said subset of collected data.

15. The method of claim 1, wherein said one or more authorized users are provided with secure credentials for accessing said evaluation tool and are selected from the group consisting of the student, a mentor assigned to the student, a supervisor of said mentor, a parent or guardian, and an employee of the student's educational institution.

16. A system for assessing student performance comprising:
a computer having a computer processor, a memory device and a display, said memory device adapted to store:
student data, comprising student attendance data, discipline data, math grade data and reading grade data;
third party data pertaining to said student;
a set of predetermined thresholds;
an activity guide comprising a plurality of potential targeted actions for intervention to improve performance or recognition to reward performance; and
computer instructions of an evaluation tool,
wherein said computer is adapted to execute said evaluation tool to:
link the student data and the third party data into collected data;
store the collected data in said memory device;
evaluate a subset of the collected data, including at least the student data, against the set of the predetermined thresholds, including determining whether the subset of collected data meets each predetermined threshold in the set of predetermined thresholds;
classify the student's performance into a classification for each of the subset of collected data based on the determination;
store the classifications in the memory device;
provide a performance score for the student wherein the performance score is based on a combination of the classifications;
display the collected data and the classifications for the student on said display; and
provide a targeted strategy for the student, wherein providing comprises:
identifying a set of targeted actions from said activity guide that correspond to the classification of the student's performance in at least one type of data in the subset of collected data; and
displaying the identified targeted actions on said display to one or more authorized users.

17. The system of claim 16, wherein said computer is further adapted to rank the targeted actions in order of importance based on said evaluation.

18. The system of claim 16, where said computer is further adapted to:
periodically receive updated student data and updated third party data about the student;
link the updated student data and updated third party data into updated collected data;
store the updated collected data in the memory device; and
evaluate the updated collected data to update the classifications, performance score and the targeted strategy.

19. The system of claim 18, wherein said computer is further adapted to adjust at least a portion of the set of predetermined thresholds based on the updated collected data.

20. The system of claim 16, wherein the set of predetermined thresholds comprises a succeeding threshold for each of the types of said subset of collected data, and a data trend threshold for each of the types of said subset of collected data, and wherein said computer is further adapted to highlight the collected data based on its classification wherein the highlighting comprises:
using a first color in accordance with a color code to highlight whether said student had met the succeeding threshold for each of the types of said subset of collected data; and,
using a second color in accordance with said color code to highlight whether said student had met the data trend threshold for each of the types of said subset of collected data.
